(19) United States
(12) Patent Application Publication
(10) Pub. No.: US 2024/0162722 A1
(43) Pub. Date: May 16, 2024

(54) POWER BALANCE IN BATTERY SYSTEMS

(71) Applicant: ESS TECH, INC., Wilsonville, OR (US)

(72) Inventors: Yang Song, Wilsonville, OR (US); Craig Evans, Wilsonville, OR (US); Timothy J. McDonald, Portland, OR (US)

(21) Appl. No.: 18/504,908

(22) Filed: Nov. 8, 2023

Related U.S. Application Data
(60) Provisional application No. 63/383,039, filed on Nov. 9, 2022.

(51) Int. Cl. H02J 7/00; H01M 8/04858; H01M 8/04992; H01M 8/18

(52) U.S. Cl. CPC H02J 7/0013; H01M 8/04895; H01M 8/04992; H01M 8/188; H02J 7/0068

(57) ABSTRACT

Systems and methods are provided for operating a battery power module. In one example, the method may include constraining an electrical parameter of the battery power module to be constant among a plurality of battery stacks of the battery power module and determining current setpoints for each of the plurality of battery stacks of the battery power module based on an estimated overpotential of each of the plurality of battery stacks of the battery power module.

### CROSS REFERENCE TO RELATED APPLICATIONS

The present application claims priority to U.S. Provisional Application No. 63/383,039 entitled “POWER BALANCE IN BATTERY SYSTEMS” filed Nov. 9, 2022. The entire contents of the above identified application is hereby included by reference for all purposes.

### FIELD

The present description relates generally to systems and methods for controlling power distribution in battery systems.

### BACKGROUND AND SUMMARY

Battery systems are attractive energy storage devices for delivering power to a variety of electrical consumers. For example, redox flow batteries are suitable for grid scale storage applications due to their capabilities of scaling power and capacity independently, and charging and discharging for thousands of cycles with minimal performance losses. Multiple redox flow battery cells (e.g., stacks) may be configured in series and/or parallel as a redox flow battery power module, in addition to other types of battery systems, to reach a target power demand of a consumer. Conventionally, the power demanded of each stack of the multiple stacks may be calculated by equation (1) below.

$${P}_{i} = \frac{{P}_{total}}{NES} \qquad ( 1 )$$

Pᵢ is the power set point of each stack of the multiple stacks, Pₜₒₜₐₗ is the total power demand for the multiple redox flow battery stacks, and NES is the number of stacks enabled in a multi-stack system. In this way, the power demand is spread evenly across each stack of the multiple stacks. However, a limitation of the above described control strategy is that a single underperforming stack may constrain a power output of the entire multi-stack system, even though at least one other stack of the multi-stack system may be capable of compensating for a power shortfall resulting from poor performance of the single underperforming stack.

The inventors have recognized the above mentioned drawbacks in controlling a multi-stack redox flow battery systems and developed a control system which at least partially overcomes the drawbacks. In one example, a method of operating a battery power module having battery stacks, comprises constraining, in real-time, an electrical parameter of the battery power module to be constant among the battery stacks based on a value of the electrical parameter for a first battery stack of the battery stacks; estimating, in real-time, an overpotential of remaining battery stacks of the battery stacks based on the value of the electrical parameter for the first battery stack; determining, in real-time, current setpoints for the remaining battery stacks based on the estimated overpotential of each of the remaining battery stacks; and operating the battery power module with each of the remaining battery stacks set at the determined current setpoints. By individually adjusting a discharging and charging current of each battery stack of the power module according to battery overpotential, underperforming batteries may be discharged at a lower current and higher performing batteries may be discharged at a higher current to make up the difference. In this way, additional power, previously limited by the lowest performing battery, may be accessed. Further, in redox flow battery systems where a metal is plated onto a negative electrode during charging, overplating of unevenly discharged batteries may be avoided by adjusting the charging current setpoint of each redox flow battery stack. The method may be readily adapted to the number of available battery stacks as batteries are added or removed from the system.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

FIG. 1 shows a schematic diagram of an example redox flow battery system including a controller.

FIG. 2 shows a side view of an example layout for the redox flow battery system of FIG. 1.

FIG. 3 shows a graph depicting limitations to current density imposed by a conventional system for power management.

FIG. 4 shows a graph depicting power foldback due to a conventional system for power management.

FIG. 5A shows an example of a high level method for operating a power module of a redox flow battery system according to an embodiment.

FIG. 5B shows an example of a method for discharging battery stacks of the power module according to an embodiment.

FIG. 5C shows an example of a method for charging battery stacks of the power module according to an embodiment.

FIG. 6 shows a graph depicting voltages of battery stacks of a redox flow battery system as a function of time for a conventional system of power management.

FIG. 7A shows a graph depicting voltages of batteries of a redox flow battery system managed conventionally.

FIG. 7B shows a graph depicting voltages of batteries of a redox flow battery system managed according to an embodiment.

FIG. 8A shows a graph depicting current of batteries of the redox flow battery system of FIG. 7A.

FIG. 8B shows a graph depicting current of batteries of the redox flow battery system of FIG. 7B.

FIG. 9A shows a graph depicting system capacity of batteries of the redox flow battery system of FIGS. 7A and 8A.

FIG. 9B shows a graph depicting system capacity of batteries of the redox flow battery system of FIGS. 7B and 8B.

FIG. 10 shows a graph comparing powers of the redox flow battery system of FIGS. 7A, 8A, and 9A and the redox flow battery system of FIGS. 7B, 8B, and 9B.

FIG. 11 shows an example of a method for operating a power module of a plating redox flow battery system, according to an embodiment.

### DETAILED DESCRIPTION

The following description relates to systems and methods for adjusting operating parameters of each battery of a battery system according to a performance of each battery. An overall battery system (e.g., power module) capacity may be constrained by any individual battery, that demonstrates reduced power output. For example, poor battery performance may arise from mechanical, e.g., hardware, issues intrinsic to components such as boost converters. As such, the strategies elaborated herein, although described with respect to redox flow batteries, may be similarly applicable to a variety of battery types, including other types of redox flow batteries besides iron redox flow batteries, both plating and non-plating redox flow batteries, and lithium ion batteries, amongst others.

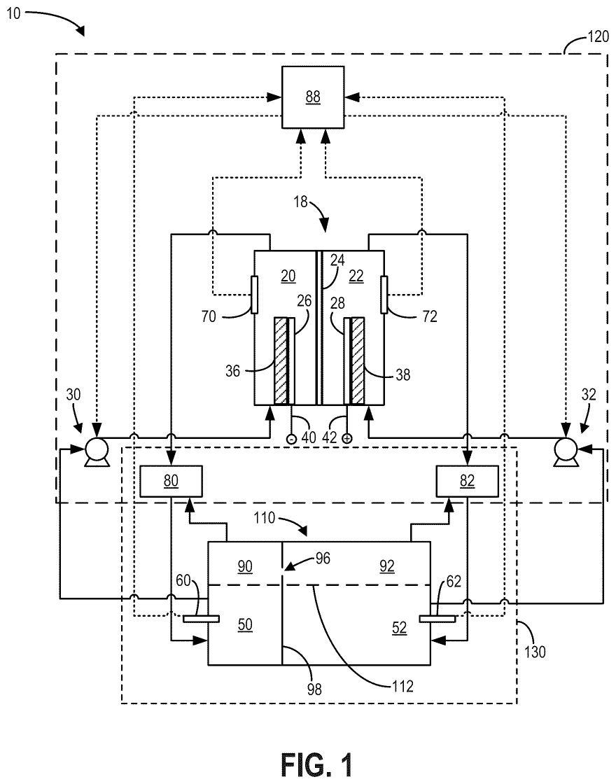

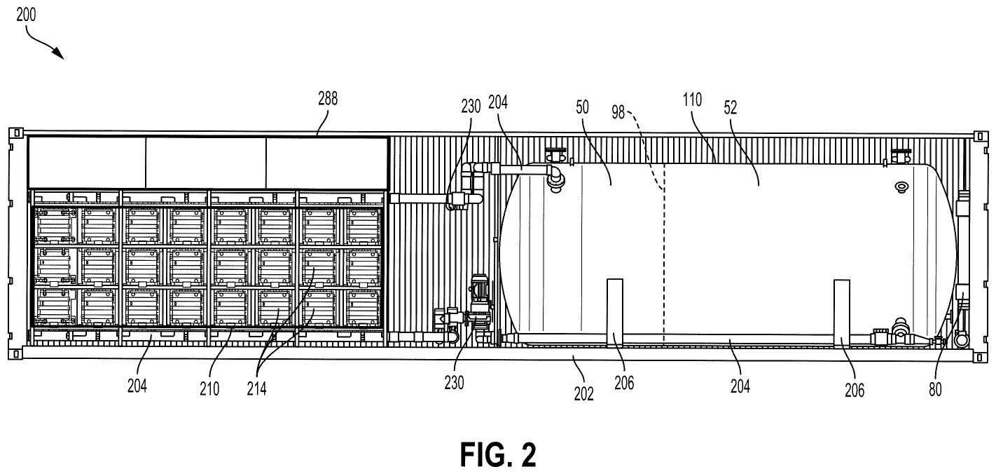

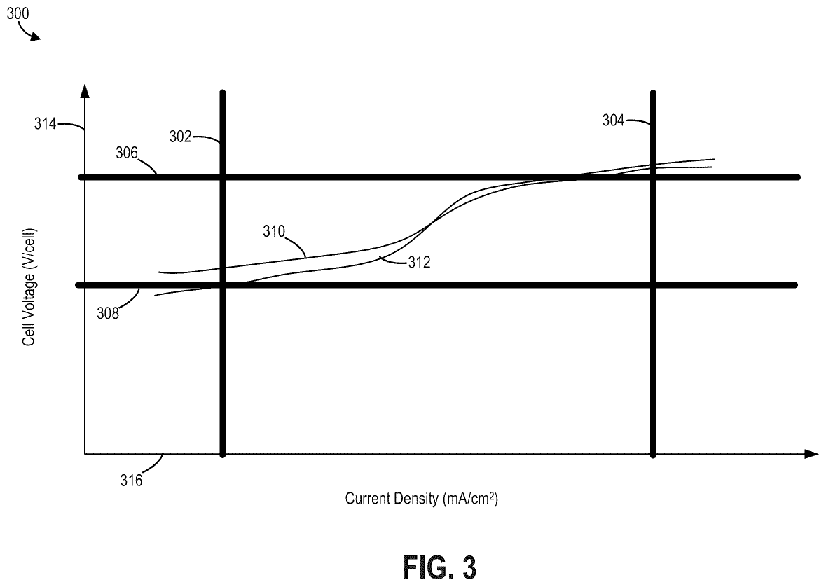

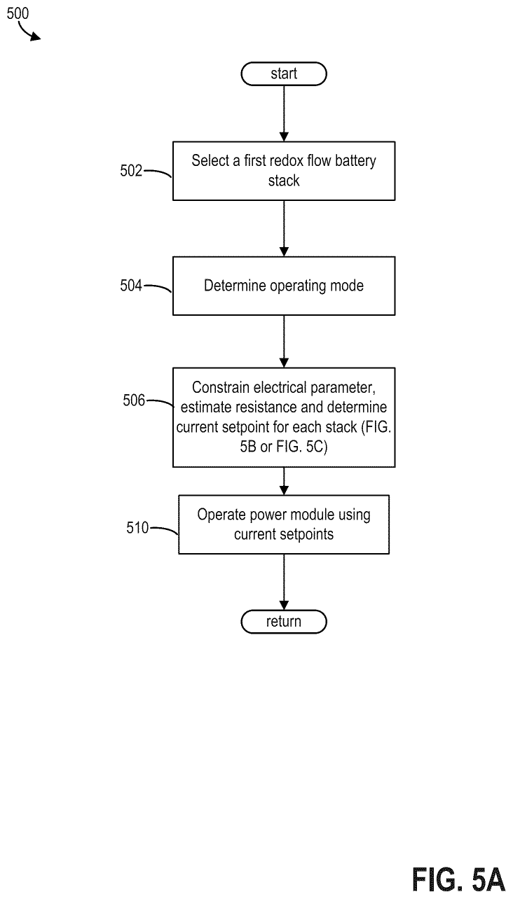

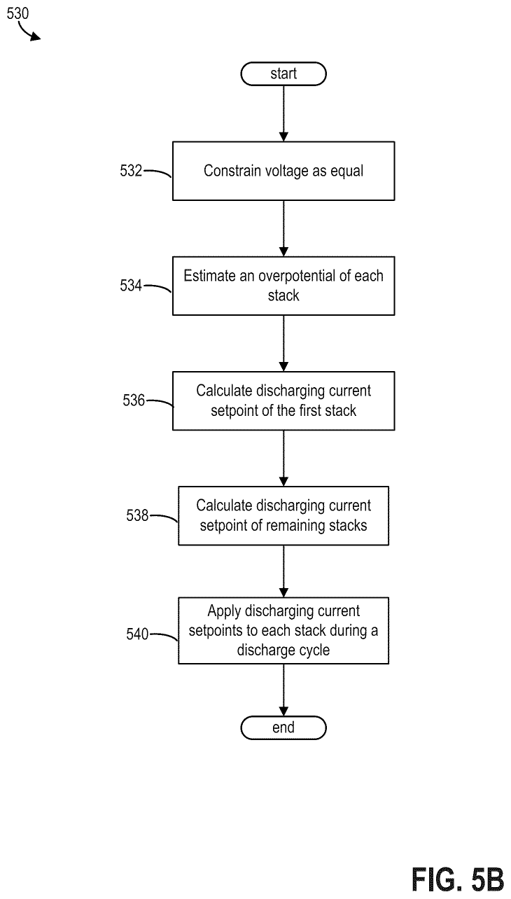

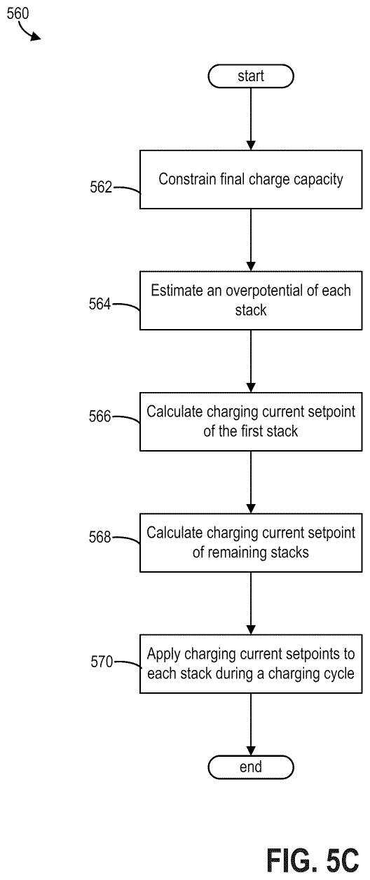

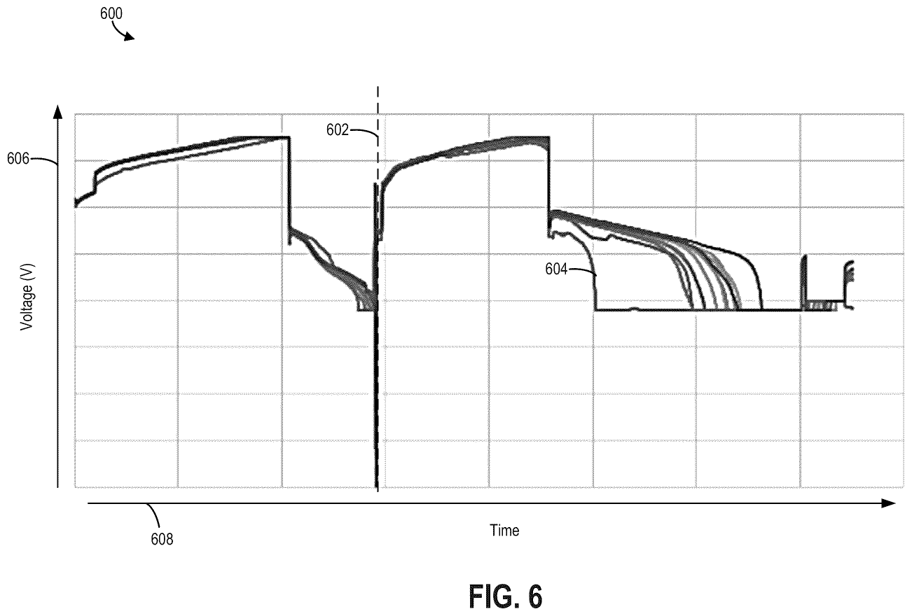

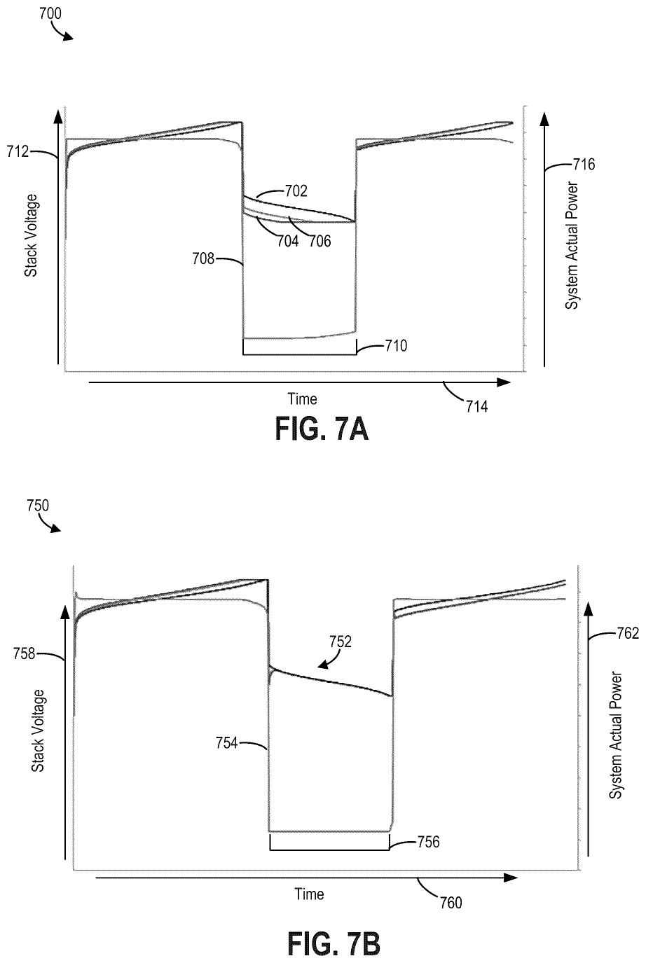

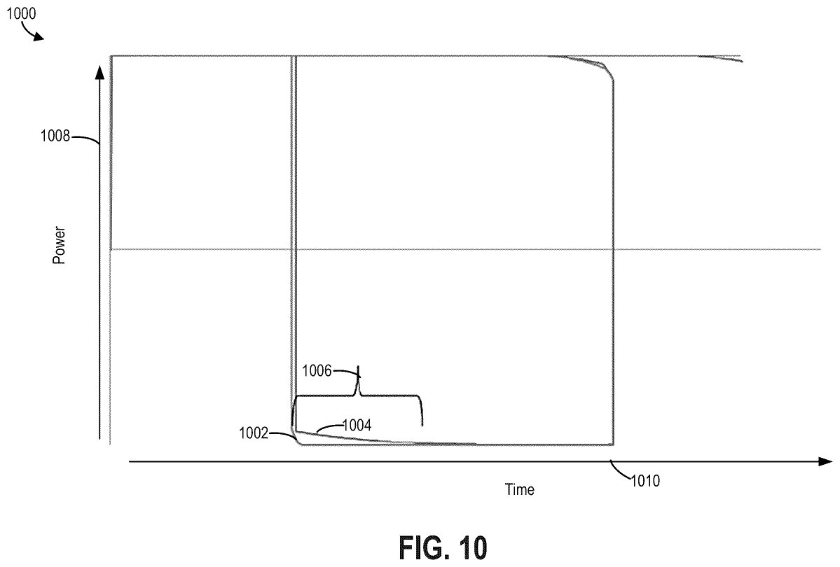

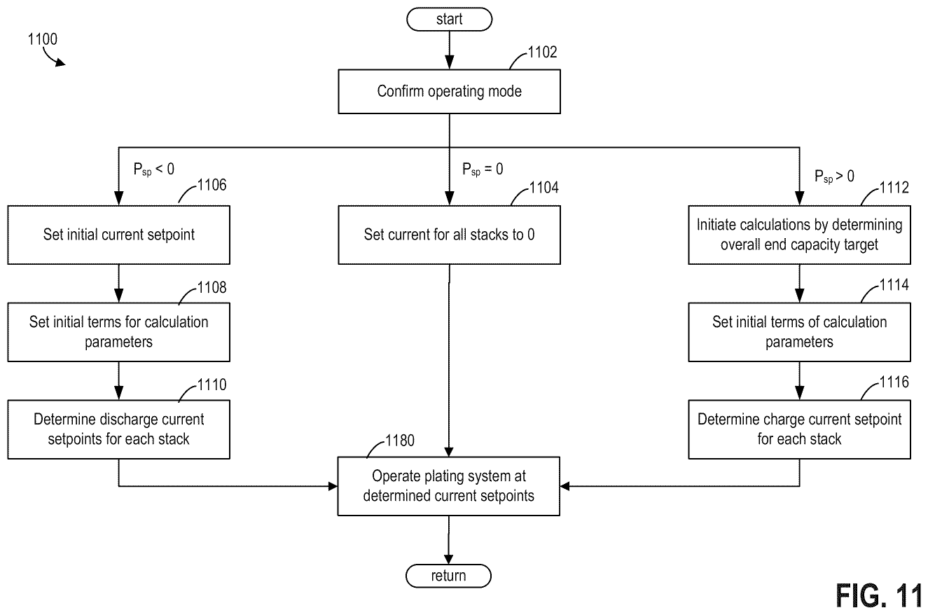

FIGS. 1 and 2 schematically show a redox flow battery and a system of multiple redox flow batteries, respectively. An operating window, shown in FIG. 3 may constrain current density and cell voltage of each redox flow battery stack of the redox flow battery system. A further example of constraints on the redox flow battery stack is shown in FIG. 6. Conventionally, when a redox flow battery stack of the redox flow battery system begins to degrade, power foldback may occur as shown in FIG. 3. Instead of allowing one or more underperforming redox flow battery stacks of the redox flow battery system to decrease a power output, a current of each redox flow battery stack may be adjusted according to a method shown at a high level in a flow chart of FIG. 5A. Details of the method of current adjustment with respect to adjusting a discharging current and adjusting a charging current are shown in FIGS. 5B and 5C, respectively. Application of the strategy described herein for power management to a plating redox flow battery system is shown in FIG. 11. A benefit of the methods shown in FIGS. 5A-5C, and 11 may be appreciated by graphs showing voltage, current, and system capacity of each battery stack of a redox flow battery system, the redox flow battery system including two battery stacks which may perform poorly. FIGS. 7A, 8A, and 9A show voltage, current, and system capacity, respectively, of a system of redox flow batteries managed conventionally, e.g., without individual adjustments to discharge and charge currents of the redox flow batteries. FIGS. 7B, 8B, and 9B show voltage, current, and system capacity, respectively of a system of redox flow batteries managed according to the methods of FIGS. 5A-5C and 11. Power outputs of the two redox flow battery systems depicted in FIGS. 7A-9B are shown in FIG. 10.

As shown in FIG. 1, in a redox flow battery system 10, a negative electrode 26 may be referred to as a plating electrode and a positive electrode 28 may be referred to as a redox electrode. A negative electrolyte within a plating side (e.g., a negative electrode compartment 20) of a redox flow battery cell 18 may be referred to as a plating electrolyte, and a positive electrolyte on a redox side (e.g., a positive electrode compartment 22) of the redox flow battery cell 18 may be referred to as a redox electrolyte.

“Anode” refers to an electrode where electroactive material loses electrons and “cathode” refers to an electrode where electroactive material gains electrons. During battery charge, the negative electrolyte gains electrons at the negative electrode 26, and the negative electrode 26 is the cathode of the electrochemical reaction. During battery discharge, the negative electrolyte loses electrons, and the negative electrode 26 is the anode of the electrochemical reaction. Alternatively, during battery discharge, the negative electrolyte and the negative electrode 26 may be respectively referred to as an anolyte and the anode of the electrochemical reaction, while the positive electrolyte and the positive electrode 28 may be respectively referred to as a catholyte and the cathode of the electrochemical reaction. During battery charge, the negative electrolyte and the negative electrode 26 may be respectively referred to as the catholyte and the cathode of the electrochemical reaction, while the positive electrolyte and the positive electrode 28 may be respectively referred to as the anolyte and the anode of the electrochemical reaction. For simplicity, the terms “positive” and “negative” are used herein to refer to the electrodes, electrolytes, and electrode compartments in redox flow battery systems.

One example of a hybrid redox flow battery is an all-iron redox flow battery (IFB), in which the electrolyte includes iron ions in the form of iron salts (e.g., FeCl₂, FeCl₃, and the like), wherein the negative electrode 26 includes metal iron. For example, at the negative electrode 26, ferrous iron (Fe²⁺) gains two electrons and plates as iron metal (Fe⁰) onto the negative electrode 26 during battery charge, and Fe⁰ loses two electrons and re-dissolves as Fe²⁺ during battery discharge. At the positive electrode 28, Fe²⁺ loses an electron to form ferric iron (Fe³⁺) during battery charge, and Fe³⁺ gains an electron to form Fe²⁺ during battery discharge. The electrochemical reaction is summarized in chemical equations (I) and (II), wherein the forward reactions (left to right) indicate electrochemical reactions during battery charge, while the reverse reactions (right to left) indicate electrochemical reactions during battery discharge:

Fe²⁺+2e⁻↔Fe⁰ −0.44 V (negative electrode) (I)

Fe²⁺↔2Fe³⁺+2e⁻ +0.77 V (positive electrode) (II)

As discussed above, the negative electrolyte used in the IFB may provide a sufficient amount of Fe²⁺ so that, during battery charge, Fe²⁺ may accept two electrons from the negative electrode 26 to form Fe⁰ and plate onto a substrate. During battery discharge, the plated Fe⁰ may lose two electrons, ionizing into Fe²⁺ and dissolving back into the electrolyte. An equilibrium potential of the above reaction is −0.44 V and this reaction therefore provides a negative terminal for the desired system. On the positive side of the IFB, the electrolyte may provide Fe²⁺ during battery charge which loses an electron and oxidizes to Fe³⁺. During battery discharge, Fe³⁺ provided by the electrolyte becomes Fe²⁺ by absorbing an electron provided by the positive electrode 28. An equilibrium potential of this reaction is +0.77 V, creating a positive terminal for the desired system.

The IFB may provide the ability to charge and recharge electrolytes therein in contrast to other battery types utilizing non-regenerating electrolytes. Charge may be achieved by respectively applying an electric current across the electrodes 26 and 28 via terminals 40 and 42. The negative electrode 26 may be electrically coupled via the terminal 40 to a negative side of a voltage source so that electrons may be delivered to the negative electrolyte via the positive electrode 28 (e.g., as Fe²⁺ is oxidized to Fe³⁺ in the positive electrolyte in the positive electrode compartment 22). The electrons provided to the negative electrode 26 may reduce the Fe²⁺ in the negative electrolyte to form Fe⁰ at the (plating) substrate, causing the Fe²⁺ to plate onto the negative electrode 26.

Discharge may be sustained while Fe⁰ remains available to the negative electrolyte for oxidation and while Fe³⁺ remains available in the positive electrolyte for reduction. As an example, Fe³⁺ availability may be maintained by increasing a concentration or a volume of the positive electrolyte in the positive electrode compartment 22 side of the redox flow battery cell 18 to provide additional Fe³⁺ ions via an external source, such as an external positive electrolyte chamber 52. More commonly, availability of Fe⁰ during discharge may be an issue in IFB systems, wherein the Fe⁰ available for discharge may be proportional to a surface area and a volume of the negative electrode substrate, as well as to a plating efficiency. Charge capacity may be dependent on the availability of Fe²⁺ in the negative electrode compartment 20. As an example, Fe²⁺ availability may be maintained by providing additional Fe²⁺ ions via an external source, such as an external negative electrolyte chamber 50 to increase a concentration or a volume of the negative electrolyte to the negative electrode compartment 20 side of the redox flow battery cell 18.

In an IFB, the positive electrolyte may include ferrous iron, ferric iron, ferric complexes, or any combination thereof, while the negative electrolyte may include ferrous iron or ferrous complexes, depending on a state of charge (SOC) of the IFB system. As previously mentioned, utilization of iron ions in both the negative electrolyte and the positive electrolyte may allow for utilization of the same electrolytic species on both sides of the redox flow battery cell 18, which may reduce electrolyte cross-contamination and may increase the efficiency of the IFB system, resulting in less electrolyte replacement as compared to other redox flow battery systems.

Efficiency losses in an IFB may result from electrolyte crossover through a separator 24 (e.g., ion-exchange membrane barrier, microporous membrane, and the like). For example, Fe³⁺ ions in the positive electrolyte may be driven toward the negative electrolyte by a Fe³⁺ ion concentration gradient and an electrophoretic force across the separator 24. Subsequently, Fe³⁺ ions penetrating the separator 24 and crossing over to the negative electrode compartment 20 may result in coulombic efficiency losses. Fe³⁺ ions crossing over from the low pH redox side (e.g., more acidic positive electrode compartment 22) to the high pH plating side (e.g., less acidic negative electrode compartment 20) may result in precipitation of Fe(OH)₃. Precipitation of Fe(OH)₃ may degrade the separator 24 and cause permanent battery performance and efficiency losses. For example, Fe(OH)₃ precipitate may chemically foul an organic functional group of an ion-exchange membrane or physically clog micropores of the ion-exchange membrane. In either case, due to the Fe(OH)₃ precipitate, membrane ohmic resistance may rise over time and battery performance may degrade. Precipitate may be removed by washing the IFB with acid, but constant maintenance and downtime may be disadvantageous for commercial battery applications. Furthermore, washing may be dependent on regular preparation of electrolyte, contributing to additional processing costs and complexity. Alternatively, adding specific organic acids to the positive electrolyte and the negative electrolyte in response to electrolyte pH changes may mitigate precipitate formation during battery charge and discharge cycling without driving up overall costs. Additionally, implementing a membrane barrier that inhibits Fe³⁺ ion crossover may also mitigate fouling.

Additional coulombic efficiency losses may be caused by reduction of H⁺ (e.g., protons) and subsequent formation of H₂ gas, and a reaction of protons in the negative electrode compartment 20 with electrons supplied at the plated iron metal of the negative electrode 26 to form H₂ gas. The sources of efficiency losses described above may contribute to reduced performance of individual power modules of the redox flow battery system 10, which may degrade an overall capacity of the system.

The IFB electrolyte (e.g., FeCl₂, FeCl₃, FeSO₄, Fe₂(SO₄)₃, and the like) may be readily available and may be produced at low costs. In one example, the IFB electrolyte may be formed from ferrous chloride (FeCl₂), potassium chloride (KCl), manganese(II) chloride (MnCl₂), and boric acid (H₃BO₃). The IFB electrolyte may offer higher reclamation value because the same electrolyte may be used for the negative electrolyte and the positive electrolyte, consequently reducing cross-contamination issues as compared to other systems. Furthermore, because of iron's electron configuration, iron may solidify into a generally uniform solid structure during plating thereof on the negative electrode substrate. For zinc and other metals commonly used in hybrid redox batteries, solid dendritic structures may form during plating. A stable electrode morphology of the IFB system may increase the efficiency of the battery in comparison to other redox flow batteries. Further still, iron redox flow batteries may reduce the use of toxic raw materials and may operate at a relatively neutral pH as compared to other redox flow battery electrolytes. Accordingly, IFB systems may reduce environmental hazards as compared with all other current advanced redox flow battery systems in production.

Continuing with FIG. 1, a schematic illustration of the redox flow battery system 10 is shown. The redox flow battery system 10 may include the redox flow battery cell 18 fluidly coupled to an integrated multi-chambered electrolyte storage tank 110. The re vdox flow battery cell 18 may include the negative electrode compartment 20, separator 24, and positive electrode compartment 22. The separator 24 may include an electrically insulating ionic conducting barrier which prevents bulk mixing of the positive electrolyte and the negative electrolyte while allowing conductance of specific ions therethrough. For example, and as discussed above, the separator 24 may include an ion-exchange membrane and/or a microporous membrane.

The negative electrode compartment 20 may include the negative electrode 26, and the negative electrolyte may include electroactive materials. The positive electrode compartment 22 may include the positive electrode 28, and the positive electrolyte may include electroactive materials. In some examples, multiple redox flow battery cells 18 may be combined in series or in parallel to generate a higher voltage or electric current in the redox flow battery system 10.

Further illustrated in FIG. 1 are negative and positive electrolyte pumps 30 and 32, both used to pump electrolyte solution through the redox flow battery system 10. Electrolytes are stored in one or more tanks external to the cell, and are pumped via the negative and positive electrolyte pumps 30 and 32 through the negative electrode compartment 20 side and the positive electrode compartment 22 side of the redox flow battery cell 18, respectively.

The redox flow battery system 10 may also include a first bipolar plate 36 and a second bipolar plate 38, each positioned along a rear-facing side, e.g., opposite of a side facing the separator 24, of the negative electrode 26 and the positive electrode 28, respectively. The first bipolar plate 36 may be in contact with the negative electrode 26 and the second bipolar plate 38 may be in contact with the positive electrode 28. In other examples, however, the bipolar plates 36 and 38 may be arranged proximate but spaced away from the electrodes 26 and 28 and housed within the respective electrode compartments 20 and 22. In either case, the bipolar plates 36 and 38 may be electrically coupled to the terminals 40 and 42, respectively, either via direct contact therewith or through the negative and positive electrodes 26 and 28, respectively. The IFB electrolytes may be transported to reaction sites at the negative and positive electrodes 26 and 28 by the first and second bipolar plates 36 and 38, resulting from conductive properties of a material of the bipolar plates 36 and 38. Electrolyte flow may also be assisted by the negative and positive electrolyte pumps 30 and 32, facilitating forced convection through the redox flow battery cell 18. Reacted electrochemical species may also be directed away from the reaction sites by a combination of forced convection and a presence of the first and second bipolar plates 36 and 38.

As illustrated in FIG. 1, the redox flow battery cell 18 may further include the negative battery terminal 40 and the positive battery terminal 42. When a charge current is applied to the battery terminals 40 and 42, the positive electrolyte may be oxidized (loses one or more electrons) at the positive electrode 28, and the negative electrolyte may be reduced (gains one or more electrons) at the negative electrode 26. During battery discharge, reverse redox reactions may occur on the electrodes 26 and 28. In other words, the positive electrolyte may be reduced (gains one or more electrons) at the positive electrode 28, and the negative electrolyte may be oxidized (loses one or more electrons) at the negative electrode 26. An electrical potential difference across the battery may be maintained by the electrochemical redox reactions in the positive electrode compartment 22 and the negative electrode compartment 20, and may induce an electric current through a current collector while the reactions are sustained. An amount of energy stored by a redox battery may be limited by an amount of electroactive material available in electrolytes for discharge, depending on a total volume of electrolytes and a solubility of the electroactive materials.

The redox flow battery system 10 may further include the integrated multi-chambered electrolyte storage tank 110. The multi-chambered electrolyte storage tank 110 may be divided by a bulkhead 98. The bulkhead 98 may create multiple chambers within the multi-chambered electrolyte storage tank 110 so that both the positive and negative electrolytes may be included within a single tank. The negative electrolyte chamber 50 holds negative electrolyte including the electroactive materials, and the positive electrolyte chamber 52 holds positive electrolyte including the electroactive materials. The bulkhead 98 may be positioned within the multi-chambered electrolyte storage tank 110 to yield a desired volume ratio between the negative electrolyte chamber 50 and the positive electrolyte chamber 52. In one example, the bulkhead 98 may be positioned to set a volume ratio of the negative and positive electrolyte chambers 50 and 52 according to a stoichiometric ratio between the negative and positive redox reactions. FIG. 1 further illustrates a fill height 112 of the multi-chambered electrolyte storage tank 110, which may indicate a liquid level in each tank compartment. FIG. 1 also shows a gas head space 90 located above the fill height 112 of the negative electrolyte chamber 50, and a gas head space 92 located above the fill height 112 of the positive electrolyte chamber 52. The gas head space 92 may be utilized to store H₂ gas generated through operation of the redox flow battery (e.g., due to proton reduction and iron corrosion side reactions) and conveyed to the multi-chambered electrolyte storage tank 110 with returning electrolyte from the redox flow battery cell 18. The H₂ gas may be separated spontaneously at a gas-liquid interface (e.g., the fill height 112) within the multi-chambered electrolyte storage tank 110, thereby precluding having additional gas-liquid separators as part of the redox flow battery system 10. Once separated from the electrolyte, the H₂ gas may fill the gas head spaces 90 and 92. As such, the stored H₂ gas may aid in purging other gases from the multi-chambered electrolyte storage tank 110, thereby acting as an inert gas blanket for reducing oxidation of electrolyte species, which may help to reduce redox flow battery capacity losses. In this way, utilizing the integrated multi-chambered electrolyte storage tank 110 may forego having separate negative and positive electrolyte storage tanks, hydrogen storage tanks, and gas-liquid separators common to conventional redox flow battery systems, thereby simplifying a system design, reducing a physical footprint of the redox flow battery system 10, and reducing system costs.

FIG. 1 also shows a spillover hole 96, which may create an opening in the bulkhead 98 between the gas head spaces 90 and 92, and may provide a means of equalizing gas pressure between the chambers 50 and 52. The spillover hole 96 may be positioned at a threshold height above the fill height 112. The spillover hole 96 may further enable a capability to self-balance the electrolytes in each of the negative and positive electrolyte chambers 50 and 52 in the event of a battery crossover. In the case of an all-iron redox flow battery system, the same electrolyte (Fe²⁺) is used in both negative and positive electrode compartments 20 and 22, so spilling over of electrolyte between the negative and positive electrolyte chambers 50 and 52 may reduce overall system efficiency, but overall electrolyte composition, battery module performance, and battery module capacity may be maintained. Flange fittings may be utilized for all piping connections for inlets and outlets to and from the multi-chambered electrolyte storage tank 110 to maintain a continuously pressurized state without leaks. The multi-chambered electrolyte storage tank 110 may include at least one outlet from each of the negative and positive electrolyte chambers 50 and 52, and at least one inlet to each of the negative and positive electrolyte chambers 50 and 52. Furthermore, one or more outlet connections may be provided from the gas head spaces 90 and 92 for directing H₂ gas to rebalancing reactors or cells 80 and 82.

Although not shown in FIG. 1, the integrated multi-chambered electrolyte storage tank 110 may further include one or more heaters thermally coupled to each of the negative electrolyte chamber 50 and the positive electrolyte chamber 52. In alternate examples, only one of the negative and positive electrolyte chambers 50 and 52 may include one or more heaters. In the case where only the positive electrolyte chamber 52 includes one or more heaters, the negative electrolyte may be heated by transferring heat generated at the redox flow battery cell 18 to the negative electrolyte. In this way, the redox flow battery cell 18 may heat and facilitate temperature regulation of the negative electrolyte. The one or more heaters may be actuated by a controller 88 to regulate a temperature of the negative electrolyte chamber 50 and the positive electrolyte chamber 52 independently or together. For example, in response to an electrolyte temperature decreasing below a threshold temperature, the controller 88 may increase a power supplied to one or more heaters so that a heat flux to the electrolyte may be increased. The electrolyte temperature may be indicated by one or more temperature sensors mounted at the multi-chambered electrolyte storage tank 110, such as sensors 60 and 62. As examples, the one or more heaters may include coil type heaters or other immersion heaters immersed in the electrolyte fluid, or surface mantle type heaters that transfer heat conductively through the walls of the negative and positive electrolyte chambers 50 and 52 to heat the fluid therein. Other known types of tank heaters may be employed without departing from the scope of the present disclosure. Furthermore, the controller 88 may deactivate the one or more heaters in the negative and positive electrolyte chambers 50 and 52 in response to a liquid level decreasing below a solids fill threshold level. Said in another way, in some examples, the controller 88 may activate the one or more heaters in the negative and positive electrolyte chambers 50 and 52 only in response to a liquid level increasing above the solids fill threshold level. In this way, activating the one or more heaters without sufficient liquid in the negative and/or positive electrolyte chambers 50, 52 may be averted, thereby reducing a risk of overheating or burning out the heater(s).

Further still, one or more inlet connections may be provided to each of the negative and positive electrolyte chambers 50 and 52 from a field hydration system (not shown). In this way, the field hydration system may facilitate commissioning of the redox flow battery system 10, including installing, filling, and hydrating the redox flow battery system 10, at an end-use location. Furthermore, prior to commissioning the redox flow battery system 10 at the end-use location, the redox flow battery system 10 may be dry-assembled at a battery manufacturing facility different from the end-use location without filling and hydrating the redox flow battery system 10, before delivering the redox flow battery system 10 to the end-use location. In one example, the end-use location may correspond to a location where the redox flow battery system 10 is to be installed and utilized for on-site energy storage. Said another way, the redox flow battery system 10 may be designed such that, once installed and hydrated at the end-use location, a position of the redox flow battery system 10 may become fixed, and the redox flow battery system 10 may no longer be deemed a portable, dry system. Thus, from a perspective of an end-user, the dry, portable redox flow battery system 10 may be delivered on-site, after which the redox flow battery system 10 may be installed, hydrated, and commissioned. Prior to hydration, the redox flow battery system 10 may be referred to as a dry, portable system, the redox flow battery system 10 being free of or without water and wet electrolyte. Once hydrated, the redox flow battery system 10 may be referred to as a wet, non-portable system, the redox flow battery system 10 including wet electrolyte.

Further illustrated in FIG. 1, electrolyte solutions primarily stored in the multi-chambered electrolyte storage tank 110 may be pumped via the negative and positive electrolyte pumps 30 and 32 throughout the redox flow battery system 10. Electrolyte stored in the negative electrolyte chamber 50 may be pumped via the negative electrolyte pump 30 through the negative electrode compartment 20 side of the redox flow battery cell 18, and electrolyte stored in the positive electrolyte chamber 52 may be pumped via the positive electrolyte pump 32 through the positive electrode compartment 22 side of the redox flow battery cell 18.

The electrolyte rebalancing reactors 80 and 82 may be connected in line or in parallel with the recirculating flow paths of the electrolyte at the negative and positive sides of the redox flow battery cell 18, respectively, in the redox flow battery system 10. One or more rebalancing reactors may be connected in-line with the recirculating flow paths of the electrolyte at the negative and positive sides of the battery, and other rebalancing reactors may be connected in parallel, for redundancy (e.g., a rebalancing reactor may be serviced without disrupting battery and rebalancing operations) and for increased rebalancing capacity. In one example, the electrolyte rebalancing reactors 80 and 82 may be placed in a return flow path from the negative and positive electrode compartments 20 and 22 to the negative and positive electrolyte chambers 50 and 52, respectively.

The electrolyte rebalancing reactors 80 and 82 may serve to rebalance electrolyte charge imbalances in the redox flow battery system 10 occurring due to side reactions, ion crossover, and the like, as described herein. In one example, electrolyte rebalancing reactors 80 and 82 may include trickle bed reactors, where the H₂ gas and electrolyte may be contacted at catalyst surfaces in a packed bed for carrying out the electrolyte rebalancing reaction. In other examples, the rebalancing reactors 80 and 82 may include flow-through type reactors that are capable of contacting the H₂ gas and the electrolyte liquid and carrying out the electrolyte rebalancing reactions absent a packed catalyst bed.

During operation of the redox flow battery system 10, sensors and probes may monitor and control chemical properties of the electrolyte such as electrolyte pH, concentration, SOC, and the like. For example, as illustrated in FIG. 1, sensors 62 and 60 maybe be positioned to monitor positive electrolyte and negative electrolyte conditions at the positive electrolyte chamber 52 and the negative electrolyte chamber 50, respectively. In another example, sensors 62 and 60 may each include one or more electrolyte level sensors to indicate a level of electrolyte in the positive electrolyte chamber 52 and the negative electrolyte chamber 50, respectively. As another example, sensors 72 and 70, also illustrated in FIG. 1, may monitor positive electrolyte and negative electrolyte conditions at the positive electrode compartment 22 and the negative electrode compartment 20, respectively. The sensors 72 and 70 may be pH probes, optical probes, pressure sensors, voltage sensors, etc. It will be appreciated that sensors may be positioned at other locations throughout the redox flow battery system 10 to monitor electrolyte chemical properties and other properties. The redox flow battery system 10 may further include various other types of sensors, including sensors for monitoring voltage output which may be used by the controller 88 to evaluate overall system performance, as well as performances of individual battery stacks.

The redox flow battery system 10 may further include a source of H₂ gas. In one example, the source of H₂ gas may include a separate dedicated hydrogen gas storage tank. In the example of FIG. 1, H₂ gas may be stored in and supplied from the integrated multi-chambered electrolyte storage tank 110. The integrated multi-chambered electrolyte storage tank 110 may supply additional H₂ gas to the positive electrolyte chamber 52 and the negative electrolyte chamber 50. The integrated multi-chambered electrolyte storage tank 110 may alternately supply additional H₂ gas to an inlet of the electrolyte rebalancing reactors 80 and 82. As an example, a mass flow meter or other flow controlling device (which may be controlled by the controller 88) may regulate flow of the H₂ gas from the integrated multi-chambered electrolyte storage tank 110. The integrated multi-chambered electrolyte storage tank 110 may supplement the H₂ gas generated in the redox flow battery system 10. For example, when gas leaks are detected in the redox flow battery system 10 or when a reduction reaction rate is too low at low hydrogen partial pressure, the H₂ gas may be supplied from the integrated multi-chambered electrolyte storage tank 110 in order to rebalance the SOC of the electroactive materials in the positive electrolyte and the negative electrolyte. As an example, the controller 88 may supply the H₂ gas from the integrated multi-chambered electrolyte storage tank 110 in response to a measured change in pH or in response to a measured change in SOC of an electrolyte or an electroactive material.

For example, an increase in pH of the negative electrolyte chamber 50, or the negative electrode compartment 20, may indicate that H₂ gas is leaking from the redox flow battery system 10 and/or that the reaction rate is too slow with the available hydrogen partial pressure, and the controller 88, in response to the pH increase, may increase a supply of H₂ gas from the integrated multi-chambered electrolyte storage tank 110 to the redox flow battery system 10. As a further example, the controller 88 may supply H₂ gas from the integrated multi-chambered electrolyte storage tank 110 in response to a pH change, wherein the pH increases beyond a first threshold pH or decreases beyond a second threshold pH. In the case of an IFB, the controller 88 may supply additional H₂ gas to increase a rate of reduction of Fe³⁺ ions and a rate of production of protons, thereby reducing the pH of the positive electrolyte. Furthermore, the pH of the negative electrolyte may be lowered by hydrogen reduction of Fe³⁺ ions crossing over from the positive electrolyte to the negative electrolyte or by protons, generated at the positive side, crossing over to the negative electrolyte due to a proton concentration gradient and electrophoretic forces. In this manner, the pH of the negative electrolyte may be maintained within a stable region, while reducing the risk of precipitation of Fe³⁺ ions (crossing over from the positive electrode compartment 22) as Fe(OH)₃.

Other control schemes for controlling a supply rate of H₂ gas from the integrated multi-chambered electrolyte storage tank 110 responsive to a change in an electrolyte pH or to a change in an electrolyte SOC, detected by other sensors such as an oxygen-reduction potential (ORP) meter or an optical sensor, may be implemented. Further still, the change in pH or SOC triggering action of the controller 88 may be based on a rate of change or a change measured over a time period. The time period for the rate of change may be predetermined or adjusted based on time constants for the redox flow battery system 10. For example, the time period may be reduced if a recirculation rate is high, and local changes in concentration (e.g., due to side reactions or gas leaks) may quickly be measured since the time constants may be small.

The controller 88 may further execute control schemes based on an operating mode of the redox flow battery system 10. For example, and as discussed in detail below with reference to FIGS. 5-6, the controller may control charging and discharging of the redox flow battery according to a discharge capacity of the redox flow battery. Higher performing batteries may be discharged more fully while lower performing batteries may be discharged less. Further, a redox flow battery which is be charged again according to an amount of current discharged in order to prevent the plating electrode 26 from becoming over plated. Additionally or alternatively, the controller 88 may control charging and discharging of the redox flow battery cell 18 so as to cause iron preformation at the negative electrode 26 during system conditioning (where system conditioning may include an operating mode employed to optimize electrochemical performance of the redox flow battery system 10 outside of battery cycling). That is, during system conditioning, the controller 88 may adjust one or more operating conditions of the redox flow battery system 10 to plate iron metal on the negative electrode 26 to improve a battery charge capacity during subsequent battery cycling (thus, the iron metal may be preformed for battery cycling). The controller 88 may further execute electrolyte rebalancing as discussed above to rid the redox flow battery system 10 of excess hydrogen gas and reduce Fe³⁺ ion concentration. In this way, preforming iron at the negative electrode 26 and running electrolyte rebalancing during the system conditioning may increase an overall capacity of the redox flow battery cell 18 during battery cycling by mitigating iron plating loss. As used herein, battery cycling (also referred to as “charge cycling”) may include alternating between a charging mode and a discharging mode of the redox flow battery system 10.

It will be appreciated that all components apart from the sensors 60 and 62 and the integrated multi-chambered electrolyte storage tank 110 (and components included therein) may be considered as being included in a power module 120. As such, the redox flow battery system 10 may be described as including the power module 120 fluidly coupled to the integrated multi-chambered electrolyte storage tank 110 and communicably coupled to the sensors 60 and 62. In some examples, each of the power module 120 and the multi-chambered electrolyte storage tank 110 may be included in a single housing (not shown), such that the redox flow battery system 10 may be contained as a single unit in a single location. It will further be appreciated the positive electrolyte, the negative electrolyte, the sensors 60 and 62, the electrolyte rebalancing reactors 80 and 82, and the integrated multi-chambered electrolyte storage tank 110 (and components included therein) may be considered as being included in an electrolyte subsystem 130. As such, the electrolyte subsystem 130 may supply one or more electrolytes to the redox flow battery cell 18 (and components included therein).

Referring now to FIG. 2, it illustrates a side view of an example redox flow battery system layout 200 for the redox flow battery system 10. Redox flow battery system layout 200 may be housed within a housing 202 that facilitates long-distance transport and delivery of the redox flow battery system 10. In some examples, the housing 202 can include a standard steel freight container or a freight trailer that can be transported via rail, truck or ship. The redox flow battery system layout 200 can include the integrated multi-chambered electrolyte storage tank 110 and one or more rebalancing reactors (e.g., rebalancing reactor 80) positioned at a first side of the housing 202, and a power module 210, and power control system (PCS) 288 at a second side of the housing 202. Auxiliary components such as supports 206, as well as various piping 204, pumps 230, valves (not shown at FIG. 2), and the like may be included within the housing 202 (as further described above with reference to FIG. 1) for stabilizing and fluidly connecting the various components positioned therein. For example, one or more pumps 230 may be utilized to convey electrolyte from the integrated multi-chambered electrolyte storage tank 110 to one or more redox flow battery cell stacks 214 within the power module 210. Furthermore, additional pumps 230 may be utilized to return electrolyte from the power module 210 to the negative electrolyte chamber 50 or the positive electrolyte chamber 52 of the integrated multi-chambered electrolyte storage tank 110.

Power module 210 may include one or more redox flow battery cell stacks 214 electrically connected in parallel and/or in series. Each of the one or more redox flow battery cell stacks 214 may further include a plurality of redox flow battery cells, such as the redox flow battery cell 18 of FIG. 1, connected in parallel and/or series. In this way, power module 210 may be able to supply a range of current and/or voltages to external loads. The PCS 288 includes controller 88 of FIG. 1, as well as other electronics, for controlling and monitoring operation of the redox flow battery system 10. Furthermore, PCS 288 may regulate and monitor voltage supplied to external loads, as well as supplying current and/or voltage from external sources for charging of the power module 210. The PCS 288 may further regulate and control operation of the redox flow battery system 10 during an idle state or idle mode. The redox flow battery system 10 being in an idle state may include when the power module 210 is not in a charge mode or a discharge mode. As an example, the power module 210 may be in the charge mode when an external voltage or current is supplied to one or more redox flow battery cells 18 of the power module 210 resulting in reduction of electrolyte and plating of the reduced electrolyte at the bipolar plate 36 connected to the negative electrode(s) of the one or more redox flow battery cells 18. For the case of an IFB, ferrous ions may be reduced at the plating electrode(s) of one or more redox flow battery cells 18, thereby plating iron thereat during charging of the power module 210. As another example, the power module 210 may be in the discharge mode when voltage or current is supplied from one or more redox flow battery cells 18 of the power module 210 resulting in oxidation of plated metal at the negative electrode resulting in deplating (e.g., loss of metal) and solubilizing of the oxidized metal ions. For the case of an IFB, iron may be oxidized at the plating electrode of one or more redox flow battery cells 18, thereby solubilizing ferrous ions thereat during discharging of the power module 210.

As another example, PCS 288 may control a charging/discharging current and voltage of each redox flow battery stack 214 of the power module 210. Charging and discharging current may be adjusted by PCS 288 according to a power demand input to PCS 288 by a user of the power module 210. PCS 288 may control discharging of each redox flow battery stack 214 such that an underperforming redox flow battery stack may be discharged less than a high performing redox flow battery stack.

Conventionally, a PCS for a battery system, including a redox battery system as well as other types of battery systems, may evenly divide a power demand between battery stacks of a power module (e.g., a power module analogous to power module 210 of FIG. 2). However, each battery stack may not be capable of meeting its portion of the power demand and operating parameters of the battery stacks may be constrained to an operating window as shown by graph 300 in FIG. 3. The operating window may be bound, at least in part, due to operating voltage and current density tolerances of boost converters configured to step up a voltage of the power module.

Graph 300 plots cell voltage on a vertical axis as a function of current density along a horizontal axis. Arrow 314 corresponds to a direction of increase cell voltage along the y-axis and arrow 316 corresponds to a direction of increasing current density along the x-axis. Line 302 corresponds to a lower current density limit and line 304 corresponds with an upper current density limit. The upper and lower current density limits may define current density thresholds of the boost converters of the power module. Line 306 corresponds to an upper voltage boundary of the boost converters. Line 308 indicates to a lower voltage limit corresponding to a minimum operating voltage of the redox flow battery stack. Together, lines 302, 304, 306, and 308 form the operating window, constraining voltages and current densities of the redox flow battery stack. Operation outside of the operating window may lead to degradation of the boost converters and/or the battery stack. Plot 310 corresponds to a higher performing battery stack and plot 312 corresponds to an underperforming battery stack. The operating window may constrain a current and voltage provided by a battery stack and therefore a power output of the battery stack. It may be appreciated that for a given voltage, the higher performing battery stack may access higher current density than the underperforming battery stack.

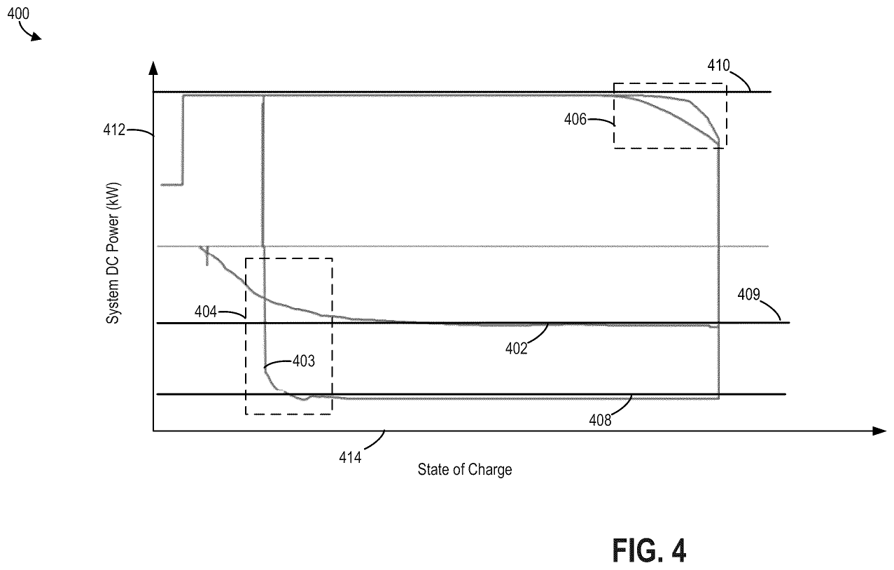

The constrained operation of the battery system may also be illustrated by graph 600 of FIG. 6. Graph 600 shows voltage as a function of time for a plurality of different battery stacks. Arrow 606 corresponds to a direction of increasing voltage along the y-axis and arrow 608 corresponds to a direction of increasing elapsed time along the x-axis. The time duration of graph 600 corresponds to charging and discharging the battery stacks over 2 cycles. Plot 602 separates a first cycle from a second cycle along the time axis. During the second cycle, a lower performing battery stack, corresponding to plot 604, may reach a lower voltage limit before the discharge cycle is ended. The lower performing battery stack may not meet the demanded power output once the lower voltage limit is reached, thus resulting in power foldback at the power module that includes the lower performing redox flow battery stack. An example of power foldback is shown in FIG. 4 as described further below.

When the power demand is evenly divided amongst a plurality of battery stacks of a battery system (e.g., according to equation 1), including at least one lower performing battery stack, a likelihood of power foldback occurring may be increased, as depicted in FIG. 4. Graph 400 shows DC power of a power module (such as power module 210 of FIG. 10) as a function of state of charge (SOC) for the power module, with the power module conventionally controlled to distribute power demand evenly between each battery stack of the power module. Arrow 412 corresponds to a direction of increasing power along the y-axis and arrow 414 corresponds to a direction of increasing state of charge along the x-axis. Plots 402 and 403 of graph 400 correspond to charging/discharging cycles for two power modules. Power foldback may herein be defined as an imposed limit on a current delivered from the power module to mitigate overcurrent at an electrical circuit coupled to the power module. As a result of power foldback, the power module may not deliver an amount of demanded power for a duration of the discharging cycle. Thus when at least one battery stack exhibits reduced performance, e.g., increased overpotential, a power output from the power module may be reduced. Areas 404 and 406 show examples of power foldback during discharging and charging, respectively. In area 404, when SOC is at a minimum (batteries are close to fully discharged), the discharge power is less than the desired power indicated by lines 408 and 409. In area 406, when SOC is at a maximum (batteries are close to fully charged), the charged power is less than the desired power indicated by line 410. The power foldback may be implemented due to constraints arising from intrinsic properties of power electronics which may lead to underperformance of one or more of the battery stacks of the power module. For example, as the battery system is charged, a cell potential at each battery cell of a battery stack may continue to increase at a fixed current. Eventually, a maximum voltage and current may be reached at which charging of the battery cell may no longer continue at a requested setpoint, where the maximum voltage and current may be imposed according to a configuration of a power module and/or performance issues at the battery cell. Because the power remains evenly distributed between the battery stacks, when one stack degrades, the power module may not provide sufficient power to meet the power demand.

A method for setting an optimum current for each battery stack of a power module during operation may allow for increased power output from the power module. Further, setting an optimum current for each battery may avoid power foldback. By setting a common electrical parameter for all of the battery stacks, a mathematical relationship between each of the battery stacks may be established and current may be set proportionally. Turning now to FIG. 5A, an example method 500 for setting a current of individual battery stacks of a power module in real-time is shown. In one example, the individual battery stacks may be redox flow battery stacks 214 of FIG. 2 and the power module may be power module 210 of FIG. 2. The power module may be part of a redox flow battery system, such as redox flow battery system 200 of FIG. 2, although other battery system types have been contemplated and may be managed in a similar manner. At least some steps or portions of steps of method 500, as well as methods shown in FIGS. 5B-5C, and 11, may be carried out via a controller, such as controller 88 of FIG. 1 and/or PCS 288 of FIG. 2, and may be stored as executable instructions at a non-transitory storage medium (e.g., memory) communicably coupled to the controller or PCS.

Method 500 may operate according to a desired power setpoint for the redox flow battery system. The power setpoint may be equal to a sum of power output by each redox flow battery stack of the power module according to equation 2 below. The power module may include any number (i) of redox flow battery stacks. A power (Pᵢ) generated by any it redox flow battery stack may be described by equation 3 below

Pₛₑₜₚₒᵢₙₜ=Σᵢ₌₁^{NES}Pᵢ (2)

Pᵢ=(V₀*Iᵢ+Iᵢ²Rᵢ) (3)

NES is the number of enabled redox flow battery stacks, V₀ is the open circuit voltage of the redox flow battery system and is therefore maintained uniformly for each battery stack. A current of an i^{th} redox flow battery stack is represented by Iᵢ, and a total overpotential of the an i^{th} redox flow battery stack is designated as Rᵢ, where the total overpotential or total losses of the redox flow battery system, includes losses due to variables such as activity, mass transport, resistance, etc. The power setpoint (Pₛₑₜₚₒᵢₙₜ) may, as one example, be set by a user input, and corresponds to a total power output demanded of the redox flow battery system (e.g., from all battery stacks). As another example, the power setpoint may be determined by the controller or another computing device communicatively coupled to the power module.

At 502, method 500 includes selecting a redox flow battery stack of the power module as a first, e.g., baseline, redox flow battery stack. The first redox flow battery stack may be chosen randomly by method 500 during an initial iteration of method 500. In one example, each execution of method 500 may include re-selection of the first redox flow battery stack, which may result in the same or a different redox flow battery stack being chosen as the baseline battery stack. As an example, subsequent to the first iteration of method 500 (e.g., after an initial designation of the first redox flow battery stack) the first redox flow battery stack may be a battery stack determined to perform at a highest level of the enabled redox flow battery stacks. Outputs resulting from implementation of method 500 may thus reflect real-time conditions of the redox flow battery stacks and current setpoints may be adjusted accordingly. By using a highest performing redox flow battery stack as a reference point for setting plating capacities of the other battery stacks, an optimal charge capacity may be obtained at each battery stack. Method 500 may be implemented repetitively and the current setpoints may be updated at a high frequency, such as 10 times per second, during operation of the power module.

At 504, method 500 includes determining an operating mode of the redox flow battery system. In one example, the operating mode may be a charging mode, a discharging mode, or an idle mode. During operation in the charging mode, the redox flow battery system may receive power from an external power source which may drive redox reactions at the redox flow battery system electrodes that cause iron to plate onto a plating electrode (such as negative electrode 26 of FIG. 1). During operation in the discharging mode, the iron may deplate from the plating electrode while power is delivered from the power module to a client/load. When operating in the idle mode, the redox flow battery system neither receives or provides power and, in some examples, electrolyte pumps driving electrolyte circulation may be deactivated.

At 506, method 500 includes constraining an electrical parameter, estimating an overpotential of each battery stack, and calculating a current setpoint for each battery stack based on the power setpoint. Determination of the current setpoint at 506 may vary depending on whether the power module is determined to be operating in a charging mode or a discharging mode, which are described in more detail with respect to FIGS. 5B and 5C below.

At 510, method 500 includes operating the power module using the current setpoints calculated at step 506. In this way, a current setpoint for each redox flow battery stack may be set according to a performance of the respective redox flow battery stack. As a result, higher performing battery stacks may compensate for underperforming battery stacks and power foldback may be avoided. Method 500 returns to the start. In some examples, method 500 may be executed multiple times, as described above, while the power module is operating in discharging mode. In this way, the current setpoints of each redox flow battery stack may be adjusted in real-time according to the power demand.

Turning now to FIG. 5B, an example of a method 530 for determining current setpoints of the battery stacks when the power module is operating in a discharging mode is shown. For example, method 530 may be implemented at 506 of method 500. As described above, method 530 may be executed while the redox flow battery system is undergoing a discharging cycle where, for example, electrolyte flow may be driven and controlled by one or more pumps and valves, and power from the redox flow battery system is delivered to a load.

At 532, method 530 includes constraining a voltage of each redox flow battery stack to be equal. A voltage of an i^{th} redox flow battery stack may be described by equation 4 below.

Vᵢ=V₀+IᵢRᵢ (4)

As described above, Iᵢ is the current for the redox flow battery stack, Rᵢ is the overpotential (e.g., total overpotential or total losses) of the redox flow battery stack, V₀ is the open circuit voltage, and Vᵢ is the set voltage of the redox flow battery stack. The open circuit voltage may be set to a fixed value or may be approximated based on a known SOC of the positive electrolyte. SOC may be determined based on algorithms and data stored in the controller and values provided by sensors, such as sensors 60 and 62 of FIG. 1. In another example, the SOC may be calculated based on a coulombic counter included in the redox flow battery system. Overpotentials may be different for each redox flow battery stack and may increase over time due to degradation of the redox flow battery stack.

Because voltages of all redox flow battery stacks are constrained to a common voltage, a relationship between the first stack and any i^{th} stack may be made according to equation 5 below, where I₁ and Rᵢ correspond to a current and overpotential of the first redox flow battery stack. Further, equation 5 may be simplified to give equation 6 which provides an equation for determining the current of any i^{th} redox flow battery stack relative to the first redox flow battery stack.

$${V}_{0} + {I}_{1} {R}_{1} = {V}_{0} + {I}_{i} {R}_{i} \qquad ( 5 )$$

$${I}_{i} = \frac{{I}_{1} {R}_{1}}{{R}_{i}} \qquad ( 6 )$$

At 534, method 530 includes estimating overpotential (e.g., total loss) for each redox flow battery stack (e.g., each individual battery stack). For example, at an initial iteration of the equation 5, a current setpoint of the redox flow battery system may be divided equally amongst the battery stacks as an initial condition to solve a voltage for each redox flow battery stack, allowing overpotential to be determined for each of the redox flow battery stacks based on the known open circuit voltage. Overpotential may be indicative of a performance level of the redox flow battery stack. For example, an underperforming redox flow battery stack may have a higher overpotential than a higher performing redox flow battery stack. Estimating overpotential in real-time may allow for current to be adjusted accordingly in real-time while the redox flow battery stacks of the power module are discharging.

The power setpoint may be set equal to a sum of Pᵢ for each redox flow battery stack of the power module. Equation 6 may be substituted for Iᵢ in equation 3 which may in turn be summed over each enabled redox flow battery stack. The resulting equation may be simplified to give equation 7 below.

$$0 = {I}_{1}^{2} {R}_{1} [ {\sum }_{i = 1}^{NES} \frac{{R}_{1}}{{R}_{i}} ] + {I}_{1} {V}_{0} [ {\sum }_{i = 1}^{NES} \frac{{R}_{1}}{{R}_{i}} ] + ( - {P}_{setpoint} ) \qquad ( 7 )$$

Equation 7 is in the form of a quadratic equation (e.g., 0=a²x+bx+c) where I₁ is x,

$${R}_{1} [ {\sum }_{i = 1}^{NES} \frac{{R}_{1}}{{R}_{i}} ] ,$$

is a,

$${V}_{0} [ {\sum }_{i = 1}^{NES} \frac{{R}_{1}}{{R}_{i}} ]$$

### is b, and (−Pₛₑₜₚₒᵢₙₜ) is c.

At 536, method 530 includes calculating the discharging current setpoint for the first redox flow battery stack. Calculating the discharging current setpoint may include solving equation 7 for I₁. A desired solution for I₁ may be the upper solution of the quadratic formula

$$( e . g . , {I}_{1} = \frac{- b + \sqrt{{b}^{2} - 4 a c}}{2 a} ) .$$

At 538, method 530 includes calculating a discharging current setpoint for the remaining redox flow battery stacks. Calculating the discharging current setpoint at 538 may include using equation 6 to solve for the current of an i^{th} redox flow battery stack relative to the discharging current setpoint and overpotential of the first redox flow battery stack. The number of enabled stacks may be adjusted during operation of the power module. For example, a redox flow battery stack may be disabled for electrolyte cleaning and replacement. In this way, method 530 may adjust in real-time to any changes in the number of enabled stacks and to changes in overpotentials of the individual redox flow battery stacks.

At 540, method 530 includes applying the calculated discharging current setpoints to each redox flow battery stack of the power module during a discharge cycle. For example, the current setpoints for the redox flow battery stacks may be determined sequentially. However, in other examples, the current setpoints for the redox flow battery stacks may be calculated non-sequentially, e.g., concurrently or in parallel, when the redox flow battery system has a multi-trend environment rather than a single trend environment. The calculated discharging current setpoints may correspond to a performance of each redox flow battery stack. An underperforming (e.g., degraded) redox flow battery stack may be calculated to have a higher overpotential than a high performing redox flow battery stack. Further, the resulting calculated discharging current setpoint according to method 530 may be a lower discharge current setpoint for the underperforming redox flow battery stack than discharge current setpoint for the high performing redox flow battery stack. Method 530 ends. Method 500 (and method 530 included therein) may be executed multiple times, as described above, while the redox flow battery system is operating in the discharging mode. In this way, the discharging current setpoints of each redox flow battery stack is adjusted in real-time according to the power demand.

Discharging redox flow battery stacks of a power module as described above, with respect to FIG. 5B, may allow a power demand of the power module to be met by setting non-uniform current setpoints at the redox flow battery stacks, according to a discharge capacity of the respective battery stack. As such, more current may be discharged from a high performing redox flow battery stack than from a lower performing battery stack and the power module delivers a demanded power output instead of experiencing power foldback and not delivering the demanded power. In some examples, the redox flow battery stacks may be included in iron redox flow batteries. During discharging of the iron redox flow battery stacks, iron may be dissolved or deplated from a negative electrode (such as electrode 26 of FIG. 1). When the iron redox flow battery stacks are assigned with different discharging current setpoints, different amounts of iron may be deplated from the negative electrodes of the iron redox flow battery stack. For example, some of the iron may be fully deplated from the respective negative electrodes, while other negative electrodes of the redox flow battery system may have iron remaining plated on the respective negative electrodes, even after a discharging cycle is ended.

If subsequent charging of the iron redox flow battery stacks, e.g., subsequent to execution of method 530, is performed using a uniform current setpoint across the iron redox flow battery stacks, non-uniform amounts of iron may be plated at the negative electrodes of the iron redox flow battery stacks. Further, at least some of the iron redox flow battery stacks, such as the battery stacks where iron was not fully deplated during discharge, may be overplated upon operation of the redox flow battery system in the charging mode. For example, for lower performing iron redox flow battery stacks discharged to a lesser degree than higher performing battery stacks, (e.g., set to a lower discharging current setpoint) an amount of plating at the lower performing iron redox flow battery stack during a subsequent charge cycle may exceed an optimum amount of plating at the respective iron redox flow battery stacks.

As such, a method for charging each redox flow battery stack of a power module to match a target final energy capacity may be desired and may include different steps than method 5B for calculating a discharging current setpoint. An example of a method specifically for power management in a plating redox flow battery system is depicted in FIG. 11. In this way, overplating of redox flow battery stacks that are discharged to a lesser extent may be avoided. By setting a common electrical parameter for all of the redox flow battery stacks, a mathematical relationship between each of the redox flow battery stacks may be established. For example, during a charging cycle, the common electrical parameter may be common final charge capacity.

Turning now to FIG. 5C, an example of a method 560 for setting a charging current set point for the redox flow battery stacks of the redox flow battery system power module is shown. Method 560 may be executed during the charging cycle of the redox flow battery system. For example, electrolyte flow may be driven and controlled by one or more pumps and valves while the battery system is operating in the charging mode.

At 562, method 560 includes constraining a final charge capacity of each redox flow battery stack to be equal. A desired energy capacity for each i^{th} redox flow battery stack may be defined by equation 8 below.

Eₜₒₜₐₗ=Eᵢ+IᵢdT (8)

Eₜₒₜₐₗ is the maximum plating (e.g., final energy capacity or final charge capacity) of the negative electrode in units of amp-sec. Eᵢ is the present plating capacity (e.g., charging capacity) of the i^{th} redox flow battery. Eₜₒₜₐₗ may be input by a user of the power module and/or may be a characteristic charge limit (e.g., plating capacity limit) of the redox flow battery stack. Eᵢ may be determined by the controller and/or sensors of the redox flow battery stack such as sensors 70 and 72 of FIG. 1.

The current plating capacity may be increased at all redox flow battery stacks of the power module from Eᵢ to Eₜₒₜₐₗ over a same amount of time as described by equation 9 below. Equation 9 can be solved for Iᵢ as shown in equation 10 below.

$$\frac{{E}_{total} - {E}_{1}}{{I}_{1}} = \frac{{E}_{total} - {E}_{i}}{{I}_{i}} \qquad ( 9 )$$

$${I}_{i} = Δ {E}_{i} {I}_{1} \qquad ( 10 )$$

ΔEᵢ may be the difference between Eₜₒₜₐₗ and Eᵢ. In this way, individual charging currents (Iᵢ) may be defined in terms of the charging current of the first redox flow battery stack. E₁ may be the current plating capacity of the first redox flow battery stack and I₁ may be the charging current of the first redox flow battery stack.

At 564, method 560 includes estimating an overpotential of each redox flow battery stack of the power module (e.g., each individual battery stack) using equation 4 as described above with respect to method 530 of FIG. 5B. Equation 10 may be combined with equation 2 to give equation 11 below.

0=I₁²[Σᵢ₌₁^{NES}ΔEᵢRᵢ]+I₁V₀[Σᵢ₌₁^{NES}ΔEᵢ]+(−Pₛₑₜₚₒᵢₙₜ) (11)

Equation 11 is in the form a quadratic equation where I₁ is x, Σᵢ₌₁^{NES} ΔEᵢRᵢ is a, V₀[ΔEᵢ] is b, and (−Pₛₑₜₚₒᵢₙₜ) is c.

At 566, method 560 includes calculating a charging current setpoint for the first redox flow battery stack. Calculating the charging current setpoint may include solving equation 11 for I₁. A desired solution of equation 11 may be the upper solution of the quadratic equation. At 568, method 560 includes calculating a charging current setpoint for the remaining stacks based on the charging current setpoint of the first redox flow battery stack, according to equation 10. Similar to method 530, the remaining stacks may include the number of enabled stacks minus the stack designated as the first stack. In this way, method 560 may adapt to redox flow battery stacks being disabled and/or re-enabled over the course of normal operation.

At 570, method 560 includes applying the charging current setpoints calculated at 566 and 568 to the redox flow battery stacks while the redox flow battery system is operating in a charging mode. The calculated charging current setpoints may be set so that an underperforming redox flow battery stack is plated less than a high performing battery stack during the charging period. Method 560 ends.

To implement a process analogous to methods 500, 530, and 560 at a plating redox flow battery system (hereafter, plating system for brevity), the controller may be configured with instructions specific to individualized determination of current setpoints for each redox flow battery stack. As described above, the plating system may be an embodiment of the redox flow battery system 10 of FIG. 1, configured with a controller and/or a PCS. An example of a method 1100 for balancing power distribution amongst redox flow battery stacks of the system, is shown in FIG. 11.

Turning now to FIG. 11, method 1100 includes, at 1102, confirming an operating mode of the plating system. For example, the controller may determine the operating mode based on whether the plating system is coupled to a voltage source, an electrical load, a status of electrolyte pumps, a SOC of the plating system, etc. If the plating system is in a stand-by mode, e.g., a power setpoint, Pₛₚ, of the plating system is equal to zero, method 1100 proceeds to 1104 to set a current at each of the battery stacks to zero. At 1118 method 1100 includes operating the plating system at the determined current setpoints (e.g., zero for Pₛₚ=0). Method 1100 then returns to the start. If the plating system is in a discharge mode (e.g., Pₛₚ is less than 0), method 1100 continues to 1106 to initiate calculations to determine discharge current setpoints for each of the battery stacks.

At 1106, an initial current setpoint may be obtained based on a predetermined overall current setpoint. The predetermined overall current setpoint may be divided equally amongst the battery stacks and used, along with an open circuit voltage of the plating system, to determine overpotentials for the battery stacks. In one example, the predetermined overall current setpoint may be based on an estimated plating system capacity corresponding to a previous charge cycle of the plating system. In some examples, the battery stacks may not have been charged to a same extent. For example, negative electrodes of battery cells corresponding to higher performing battery stacks may be deplated to a greater extent than those of lower performing battery stacks. Further, at 1108, initial values of parameters used for determining the individual current setpoints of the battery stacks may be set. For example, terms for calculating the terms of a quadratic equation, e.g., the terms a and b of equation 7, may be set to 0 to enable iterative calculation of current setpoints for the stacks. A sum of ratios (SSR) of an overpotential of a highest performing battery stack to an overpotential of a lower performing battery stack across all the battery stacks may also be set to zero.

Despite the differences in discharge capacity amongst the battery stacks, an initial iteration of the calculations may rely on setting the current setpoint to be equal to allow subsequent iterations to optimize the discharge current setpoint to each battery stack, according to plating/deplating attributes of the battery stack. Individual overpotentials of the battery stacks may then be used to sequentially determine current setpoints for each battery stack at 1110, allowing an individual current setpoint to account for an actual performance of the battery stack, thereby mitigating power foldback due to performance constraints imposed by lower performing battery stacks. Method 1100 proceeds to 1118 and includes operating the plating system at the determined discharging current setpoint. Method 1100 returns to the start.

Returning to 1102, if the plating system is operating in the charging mode (e.g., Pₛₚ is greater than 0), method 1100 proceeds to 1112 to initiate calculations to determine charge current setpoints for each battery stack. Initiating the calculations includes, for example, inferring an end capacity target for each battery stack of the plating system, which may be determined by subtracting a previous battery stack capacity from a maximum battery stack capacity. The maximum capacity may be an overall maximum rated capacity of the plating system divided equally amongst the battery stacks. The previous battery stack capacity may be determined by a previous plating system capacity, e.g. of a previous discharge cycle, which may be divided amongst the battery stacks.

At 1114, method 1100 includes setting terms of parameters used to determine charge current setpoints. For example, terms of a quadratic equation, such as equation 11 above, used to estimate a charge current setpoint of a highest performing battery stack may be assigned. As an initial iteration, the terms, e.g., a and b, of the quadratic equation are set to zero, and a current, e.g., a charge current setpoint, for the highest performing battery stacks may be determined. For example, the current of the highest performing battery stack may be used to estimate an overpotential of the battery stack. The estimated current, overpotential, and the power setpoint of the plating system may then be used to determine the charge current setpoint of the highest performing battery stack.

At 1116, method 1100 includes determining the charge current set points for each battery stack of the plating system using the charge current setpoint of the highest performing battery stack to determine the charge current setpoints for the remaining battery stacks in a sequential manner, for example. Based on the previous discharge cycle of the plating system, a charge capacity of each of the battery stacks may differ depending on an extent that the respective battery stack was discharged. In some examples, the negative electrodes of the battery cells corresponding to battery stacks of lower performance may not be fully deplated during discharge. In other words, some of the battery stacks may have negative electrodes with iron metal still present at a start of a charge cycle while others may have less or no plated iron remaining on the respective negative electrodes. By customizing the charge current setpoint for each battery stack, overplating of the battery stacks with remaining plated iron may be circumvented. Method 1100 proceeds to 1118 and includes operating the plating system at the determined charging current setpoint. Method 1100 returns to the start.

Method 1100 may enable management of stack-to-stack performance in real-time. In some examples, results provided by the method 1100 may be enhanced by modifying how stack overpotentials are estimated. For example, a Bayesian approach may be used to estimated stack overpotentials by incorporating real-time updates, which may allow large changes in power settings to be accommodated and a user to be notified if stack performance is determined to degrade. Furthermore, the Bayesian approach may enable management of pulse charging and discharging, such as maximum power point control (MPPC).

A benefit of dynamically designating a charging and discharging current setpoint to each redox flow battery stack of a power module may be appreciated by comparing results from a simulated redox flow battery system to results from a conventional redox flow battery system. For the simulated system, voltage, current and capacity of redox flow battery stacks of a power module are used to determine charging and discharging current setpoints based on the methods of FIGS. 5A-5C and the exemplary code depicted above. For the conventional system, conventional charging and discharging current setpoints (e.g., a current is adjusted according to evenly distributed power demand between the redox flow battery stacks) are used.

Turning now to FIG. 7A, graph 700 shows voltage on a left axis as a function of time for a plurality of redox flow battery stacks of a power module such as power module 210 of FIG. 2. An arrow 712 corresponds to a direction of increasing stack voltage along the left y-axis, arrow 716 corresponds to a direction of increasing system actual power along the right y-axis, and arrow 714 corresponds to a direction of increasing elapsed time along the x-axis. Plots 702, 704, and 706 correspond to voltage values of the left access. Plot 708 corresponds to system power of the power module as a function of time as read on a right axis of graph 700. A time period along the x-axis designated by bracket 710 corresponds a duration of the power module operating in discharging mode. According to a conventional control method, a uniform current setpoint may be applied to each of the plurality of redox flow battery stacks. Plot 702 corresponds to a voltage of one or more high performing redox flow battery stack. Plot 704 and plot 706 correspond to underperforming redox flow battery stacks. Plots 704 and 706 may reach a minimum voltage allowed by a controller of the power module (e.g., an edge of an operational window as described above with respect to FIG. 3), as evidenced by plots 704 and 706 flattening (reaching a constant value) before an end of the discharging period. On the other hand, plot 702 may steadily decrease over the duration of the discharging time period. As a result of the underperforming battery stacks being voltage limited by the operational window, the system power as shown by plot 708 may begin to decrease before the end of the discharge period.

In contrast, graph 750 of FIG. 7B shows voltage on a left axis as a function of time for a plurality of redox flow battery stacks of a power module where discharging and charging current setpoints are set for each redox flow battery stack according to the methods described above with respect to FIG. 5A-5C. An arrow 758 corresponds to a direction of increasing stack voltage along the left y-axis, an arrow 762 corresponds to a direction of increasing system actual power along the right y-axis, and an arrow 760 corresponds to a direction of increasing elapsed time along the x-axis. A time period along the x-axis of graph 750 designated by bracket 756 corresponds to a duration that the redox flow battery stacks are discharging. According to the method described above with respect to FIGS. 5A-5B, all voltages of the redox flow battery stacks may be constrained to be equal. Plots 752 correspond to overlapping voltages as a function of time for the plurality of redox flow battery stacks, including both high performing and underperforming redox flow battery stacks. Plot 754 may correspond to a system power shown on a right axis of graph 750 as a function of time. Unlike plot 708 of FIG. 7A, plot 754 maintains a steady system power for the duration of the discharging time period. Higher performing redox flow battery stacks of the plurality of redox flow battery stacks may output an increased power to make up for a lower power output of the underperforming redox flow battery stacks.

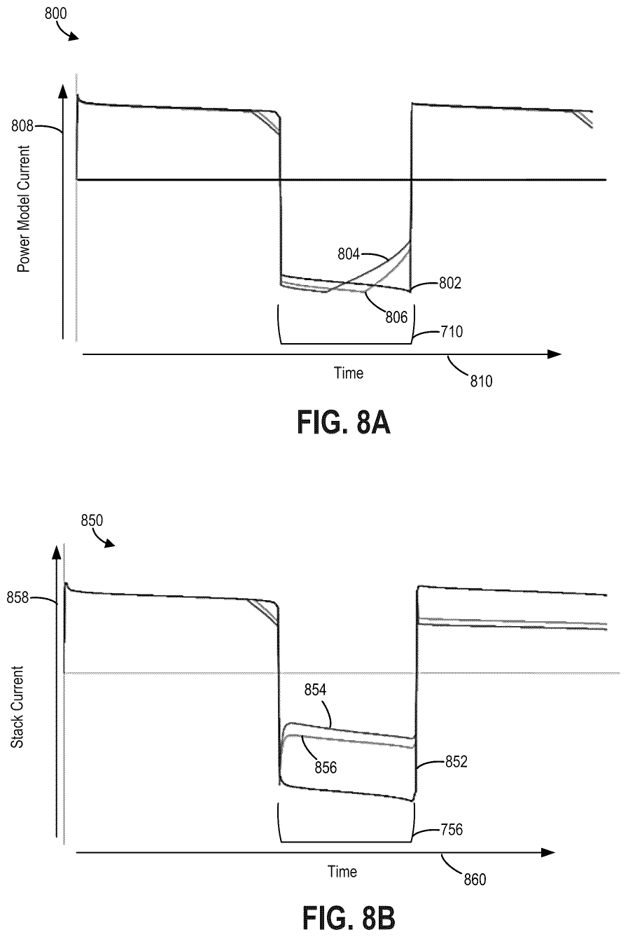

Turning now to FIG. 8A, graph 800 shows current as a function of time for the plurality of redox flow batteries described above with respect to FIG. 7A. Arrow 808 corresponds to a direction of increasing power module current along the y-axis and arrow 810 corresponds to direction of increasing elapsed time along the y-axis. Plots 802, 804, and 806 correspond to currents of the redox flow battery stacks for which voltages are shown in FIG. 7A. Plot 802 corresponds to current of the one or more high performing redox flow battery stacks and plots 804 and 806 correspond to currents of the underperforming redox flow battery stacks. While plot 802 may be substantially constant for a duration of the discharging period 710, plots 804 and 806 may decrease (become less negative) as a corresponding voltage limit needed to reach a desired power setpoint is reached. The decrease in current may be responsible for the power foldback shown above with respect to plot 708 of FIG. 7A.

On the other hand, graph 850 of FIG. 8B shows current as a function of time for the plurality of redox flow battery stacks describe above with respect to FIG. 7B. An arrow 858 corresponds to a direction of increasing stack current along the y-axis and arrow 860 corresponds to a direction of increasing elapsed time along the x-axis. Plots 852, 854, and 856 correspond currents of the redox flow battery stacks for which voltages are shown in FIG. 7B. Plot 852 corresponds to current of the one or more high performing redox flow battery stacks and plots 854 and 856 correspond to currents of the underperforming redox flow battery stacks. A current setpoint may be assigned to each redox flow battery according to whether the redox flow battery stack is high overpotential (underperforming) or low overpotential (high performance). A discharging time period along a bottom axis may correspond to a time period designated by bracket 756. Plots 856 and 854 may show discharging current adjusted in real-time to lower (less negative) discharging current in response to a measured overpotential of each redox flow battery stack. Plot 852 may shows discharging current adjusted to a higher (more negative) value to make up for the decreased charging current of the underperforming redox flow battery stacks.

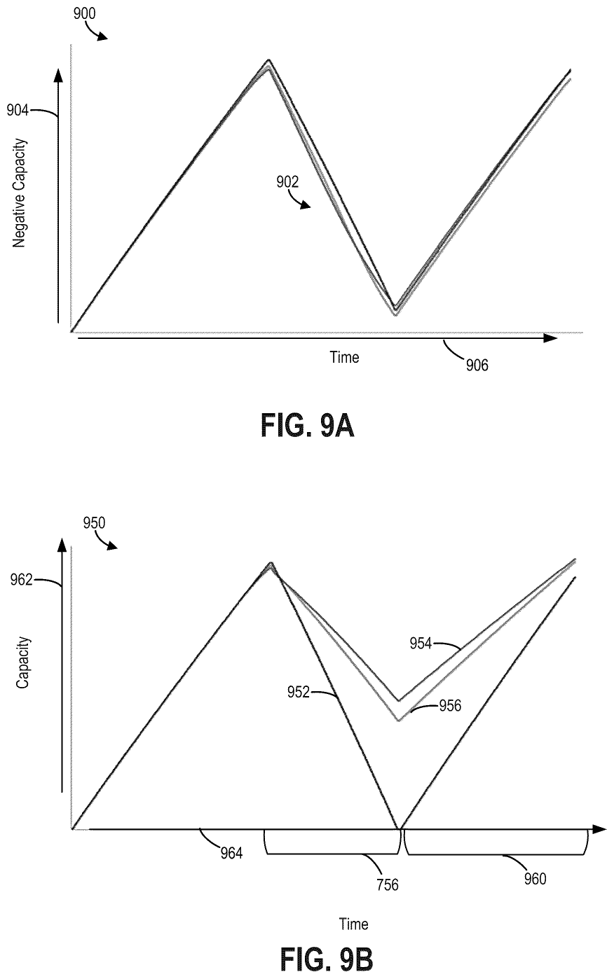

Turning now to FIG. 9A, graph 900 shows system capacity on a left axis as a function of time for the plurality of redox flow batteries described above with respect to FIG. 7A. Arrow 904 corresponds to a direction of increasing negative capacity along the y-axis and arrow 906 corresponds to a direction of increasing elapsed time along the x-axis. Plots 902 may correspond to overlapping plots of both high performing and underperforming redox flow battery stacks. Because a discharging current of the redox flow battery stacks may be substantially the same, the system capacity change over time may also be substantially the same for each of the plurality of redox flow battery stacks.

In contrast, graph 950 of FIG. 9B shows system capacity on a left axis as function of time for the redox flow battery stacks described above with respect to FIG. 7B. Arrow 962 corresponds to a direction of increasing capacity along the y-axis and arrow 964 corresponds to a direction of increasing elapsed time along the x-axis. Because the redox flow battery stacks may be discharged according to method 500 discussed above with respect to FIG. 5A, the redox flow battery stacks may be charged according to method 560 discussed above with respect to FIG. 5C. Plot 952 corresponds to capacity of the one or more high performing redox flow battery stacks as shown in plots 752 and 852 of FIGS. 7B and 8B, respectively. Plots 954 and 956 correspond to the underperforming redox flow battery stacks as shown in plots 754 and 756 of FIG. 7B and plots 854 and 856 of FIG. 8B. A time period along a bottom axis of graph 950 designated by bracket 756 corresponds to the discharging period, while a time period designated by bracket 960 corresponds to a charging period. Plot 952 reaches a capacity of substantially equal to zero by the end of the discharging period while plots 954 and 956 are higher than zero. The plots corresponding to the underperforming redox flow battery stacks may retain a higher capacity after discharging than the traces corresponding to the one or more higher performing redox flow battery stacks because a discharging current of the underperforming redox flow battery stacks was kept lower than that of the high performance battery stack. Plots 952, 954, and 956 all show an increase in capacity during the charging period. However, a slope of plots 952, 954, and 956 during the charging period may be different such that plots may converge to the same capacity at the end of the charging period from starting at different capacities at a beginning of the charging period.

Turning now to FIG. 10, a graph 1000 shows power as a function of energy for the two power modules described above with respect to FIGS. 7A-9B. An arrow 1008 corresponds to a direction of increasing power along the y-axis and arrow 1010 corresponds to a direction of increasing elapsed time along the x-axis. Plot 1004 may correspond to a power module controlled by a conventional method as shown in FIGS. 7A, 8A, and 9A. Plot 1002 may correspond to a power module controlled by the methods described above with respect to FIGS. 5A-5C. Bracket 1006 may correspond to an energy range along an energy range indicated along the x-axis where the power module is controlled according to the methods described above in FIGS. 5A-5C. At bracket 1006, an increase in power output over the power module controlled by the conventional method is demonstrated.

The technical effect of methods described in this application is that a power output of a power module may be increased by removing power constraints imposed by one or more lowest performing battery stacks of the power module. By adjusting a discharging current of each battery stack according to a performance of the battery stack in real-time, power foldback may be avoided. Further, adjusting a charging current of each battery stack according to a common final energy capacity may avoid overplating at negative electrodes of the battery stacks when the battery stacks are implemented in a plating redox flow battery system. Charging and discharging currents may be adjusted in real-time according to the disclosed methods depending on a number of enabled stacks of the power module. By adjusting the charging and discharging current according to a performance of each of the enabled battery stacks, current setpoints may be optimized for each battery stack, thereby allowing a target power output of the power module to be met.

The disclosure also provides support for a method of operating a battery power module having battery stacks, comprising: constraining, in real-time, an electrical parameter of the battery power module to be constant among the battery stacks based on a value of the electrical parameter for a first battery stack of the battery stacks, estimating, in real-time, an overpotential of remaining battery stacks of the battery stacks based on the value of the electrical parameter for the first battery stack, determining, in real-time, current setpoints for the remaining battery stacks based on the estimated overpotential of each of the remaining battery stacks, and operating the battery power module with each of the remaining battery stacks set at the determined current setpoints. In a first example of the method, the overpotential of an individual battery stack of the battery stacks is estimated based on a set voltage, open circuit voltage, and current of the individual battery stack. In a second example of the method, optionally including the first example subsequent to an initial designation of the first battery stack, the first battery stack is selected based on a highest performing battery stack of the battery stacks. In a third example of the method, optionally including one or both of the first and second examples, selection of the first battery stack is updated at a frequency of 10 times per second. In a fourth example of the method, optionally including one or more or each of the first through third examples, the electrical parameter is voltage when the battery power module is operated in a discharge mode. In a fifth example of the method, optionally including one or more or each of the first through fourth examples, the electrical parameter is charge capacity when the battery power module is operated in a charge mode. In a sixth example of the method, optionally including one or more or each of the first through fifth examples, the current setpoints may be a charging current setpoint or a discharging current setpoint.

The disclosure also provides support for a method of operating a redox flow battery power module, comprising: responsive to the redox flow battery power module operating in a discharging mode, estimating, in real-time, a overpotential of each redox flow battery stack of the redox flow battery power module, and setting, in real-time, a discharging current setpoint for each redox flow battery stack based on the estimated overpotential of each redox flow battery stack and a power setpoint of the redox flow battery power module, and responsive to the redox flow battery power module operating in a charging mode, estimating, in real-time, the overpotential of each redox flow battery stack of the redox flow battery power module, and setting, in real-time, a charging current setpoint for each redox flow battery stack based on the estimated overpotential of each redox flow battery stack and a charging capacity of each redox flow battery stack. In a first example of the method, setting the discharging current setpoint for each redox flow battery stack further comprises designating a first redox flow battery stack and determining a discharging current setpoint of the first redox flow battery stack. In a second example of the method, optionally including the first example, setting the discharging current setpoint for each redox flow battery stack further comprises calculating the discharging current setpoint of each redox flow battery stack based on the determined discharging current setpoint of the first redox flow battery stack. In a third example of the method, optionally including one or both of the first and second examples, calculating the discharging current setpoint for each redox flow battery stack further comprises constraining all redox flow battery stacks to a common voltage. In a fourth example of the method, optionally including one or more or each of the first through third examples, setting the charging current setpoint for each redox flow battery further comprises designating a first redox flow battery stack and determining a charging current setpoint of the first redox flow battery stack. In a fifth example of the method, optionally including one or more or each of the first through fourth examples, setting the charging current setpoint of each redox flow battery stack further comprises calculating the charging current setpoint of each redox flow battery stack based on the determined charging current setpoint of the first redox flow battery stack. In a sixth example of the method, optionally including one or more or each of the first through fifth examples, solving for the charging current setpoint further comprises setting a common final charge capacity for each redox flow battery stack.

The disclosure also provides support for a redox flow battery system, comprising: a redox flow battery power module, including a plurality of redox flow battery stacks, and a controller, including executable instructions stored on non-transitory memory that, when executed, cause the controller to: constrain, in real-time, an electrical parameter of the redox flow battery power module to be constant among the plurality of redox flow battery stacks based on a value of the electrical parameter for a first redox flow battery stack of the plurality of redox flow battery stacks, estimate, in real-time, an overpotential of remaining redox flow battery stacks of the plurality of redox flow battery stacks based on the value of the electrical parameter for the first redox flow battery stack, determine, in real-time, current setpoints for the remaining redox flow battery stacks based on the estimated overpotential of each of the remaining redox flow battery stacks, and operate the redox flow battery power module with each of the remaining redox flow battery stacks set at the determined current setpoints. In a first example of the system, an underperforming redox flow battery stack of the plurality of redox flow battery stacks is discharged with a lower discharge current setpoint then a higher performing redox flow battery stack of the plurality of redox flow battery stacks. In a second example of the system, optionally including the first example, an overpotential of the underperforming redox flow battery stack is higher than an overpotential of the higher performing redox flow battery stack. In a third example of the system, optionally including one or both of the first and second examples, the underperforming redox flow battery stack is deplated less than the higher performing redox flow battery stack during a discharging cycle. In a fourth example of the system, optionally including one or more or each of the first through third examples, the controller executes the executable instructions at a frequency of 10 times per second. In a fifth example of the system, optionally including one or more or each of the first through fourth examples, the redox flow battery system delivers a demanded power output for a duration of a discharging cycle.

In an alternate embodiment, the disclosure also provides support for a method of operating a redox flow battery power module having redox flow battery stacks, comprising: during operation of the redox flow battery power module in a discharge mode, selecting a first battery stack of the redox flow battery stacks, the first battery stack demonstrating a highest performance of the redox flow battery stacks, constraining a voltage to be constant amongst the redox flow battery stacks, the voltage based on the first battery stack, estimating overpotential of the redox flow battery stacks based on the voltage, determining discharge current setpoints for the redox flow battery stacks according to the estimated overpotential, and discharging the redox flow battery power module according to the discharge current setpoints.

In an additional alternate embodiment, the disclosure also provides support for a method of operating a redox flow battery power module having redox flow battery stacks, comprising: during operation of the redox flow battery power module in a charge mode, selecting a first battery stack of the redox flow battery stacks, the first battery stack demonstrating a highest performance of the redox flow battery stacks, constraining a charge capacity to be constant amongst the redox flow battery stacks, the charge capacity based on the first battery stack, estimating overpotential of the redox flow battery stacks based on the charge capacity, determining charge current setpoints for the redox flow battery stacks according to the estimated overpotential, and charging the redox flow battery power module according to the charge current setpoints.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A method of operating a battery power module having battery stacks, comprising:
constraining, in real-time, an electrical parameter of the battery power module to be constant among the battery stacks based on a value of the electrical parameter for a first battery stack of the battery stacks;
estimating, in real-time, an overpotential of remaining battery stacks of the battery stacks based on the value of the electrical parameter for the first battery stack;
determining, in real-time, current setpoints for the remaining battery stacks based on the estimated overpotential of each of the remaining battery stacks; and
operating the battery power module with each of the remaining battery stacks set at the determined current setpoints.

2. The method of claim 1, wherein the overpotential of an individual battery stack of the battery stacks is estimated based on a set voltage, open circuit voltage, and current of the individual battery stack.

3. The method of claim 1, wherein, subsequent to an initial designation of the first battery stack, the first battery stack is selected based on a highest performing battery stack of the battery stacks.

4. The method of claim 3, wherein selection of the first battery stack is updated at a frequency of 10 times per second.

5. The method of claim 1, wherein the electrical parameter is voltage when the battery power module is operated in a discharge mode.

6. The method of claim 1, wherein the electrical parameter is charge capacity when the battery power module is operated in a charge mode.

7. The method of claim 1, wherein the current setpoints may be a charging current setpoint or a discharging current setpoint.

8. A method of operating a redox flow battery power module, comprising:
responsive to the redox flow battery power module operating in a discharging mode;
estimating, in real-time, a overpotential of each redox flow battery stack of the redox flow battery power module; and
setting, in real-time, a discharging current setpoint for each redox flow battery stack based on the estimated overpotential of each redox flow battery stack and a power setpoint of the redox flow battery power module; and
responsive to the redox flow battery power module operating in a charging mode;
estimating, in real-time, the overpotential of each redox flow battery stack of the redox flow battery power module; and
setting, in real-time, a charging current setpoint for each redox flow battery stack based on the estimated overpotential of each redox flow battery stack and a charging capacity of each redox flow battery stack.

9. The method of claim 8, wherein setting the discharging current setpoint for each redox flow battery stack further comprises designating a first redox flow battery stack and determining a discharging current setpoint of the first redox flow battery stack.

10. The method of claim 9, wherein setting the discharging current setpoint for each redox flow battery stack further comprises calculating the discharging current setpoint of each redox flow battery stack based on the determined discharging current setpoint of the first redox flow battery stack.

11. The method of claim 10, wherein calculating the discharging current setpoint for each redox flow battery stack further comprises constraining all redox flow battery stacks to a common voltage.

12. The method of claim 8, wherein setting the charging current setpoint for each redox flow battery further comprises designating a first redox flow battery stack and determining a charging current setpoint of the first redox flow battery stack.

13. The method of claim 12, wherein setting the charging current setpoint of each redox flow battery stack further comprises calculating the charging current setpoint of each redox flow battery stack based on the determined charging current setpoint of the first redox flow battery stack.

14. The method of claim 13, wherein solving for the charging current setpoint further comprises setting a common final charge capacity for each redox flow battery stack.

15. A redox flow battery system, comprising:
a redox flow battery power module, including a plurality of redox flow battery stacks; and
a controller, including executable instructions stored on non-transitory memory that, when executed, cause the controller to:
constrain, in real-time, an electrical parameter of the redox flow battery power module to be constant among the plurality of redox flow battery stacks based on a value of the electrical parameter for a first redox flow battery stack of the plurality of redox flow battery stacks;
estimate, in real-time, an overpotential of remaining redox flow battery stacks of the plurality of redox flow battery stacks based on the value of the electrical parameter for the first redox flow battery stack;
determine, in real-time, current setpoints for the remaining redox flow battery stacks based on the estimated overpotential of each of the remaining redox flow battery stacks; and
operate the redox flow battery power module with each of the remaining redox flow battery stacks set at the determined current setpoints.

16. The redox flow battery system of claim 15, wherein an underperforming redox flow battery stack of the plurality of redox flow battery stacks is discharged with a lower discharge current setpoint then a higher performing redox flow battery stack of the plurality of redox flow battery stacks.

17. The redox flow battery system of claim 16, wherein an overpotential of the underperforming redox flow battery stack is higher than an overpotential of the higher performing redox flow battery stack.

18. The redox flow battery system of claim 16, wherein the underperforming redox flow battery stack is deplated less than the higher performing redox flow battery stack during a discharging cycle.

19. The redox flow battery system of claim 15, wherein the controller executes the executable instructions at a frequency of 10 times per second.

20. The redox flow battery system of claim 15, wherein the redox flow battery system delivers a demanded power output for a duration of a discharging cycle.
